(19) United States
(12) Patent Application Publication
(10) Pub. No.: US 2005/0286421 A1
(43) Pub. Date: Dec. 29, 2005

(54) Location determination for mobile devices for location-based services

(76) Inventor: Thomas Janacek, Calgary (CA)

Correspondence Address: JAMES D IVEY, 3025 TOTTERDELL STREET, OAKLAND, CA, 94611-1742, US

(21) Appl. No.: 10/877,756

(22) Filed: Jun. 24, 2004

(51) Int. Cl. H04L 1/00

(52) U.S. Cl. 370/231

(57) ABSTRACT

Information regarding a site-specific m-commerce transaction is used to determine the general location of a mobile device with which the m-commerce transaction is conducted. All that is required for location determination of the mobile device is a location identifier. During the transaction, the user specifies the location identifier. An m-commerce server retrieves predetermined and previously stored location information associated with the location identifier. The server identifies services associated with locations within a predetermined distance of the identified location and makes information regarding such services available to the mobile device.

### FIELD OF THE INVENTION

This invention relates to the field of wireless voice and data communications and, in particular, to an efficient and reliable mechanism for determining a location of a mobile device for the purpose of delivering location-based services to the mobile device.

### BACKGROUND

Following closely on the heels of e-commerce—in which business was conducted on the Internet—is m-commerce, i.e., business conducted on small mobile devices which communicate through wireless data protocols. One of the particularly interesting aspects of m-commerce is the ability to gather information regarding products and services which are in relatively close proximity to the mobile device itself (and, more importantly, the person carrying the mobile device). The providing of information related to products and services in close proximity to the mobile device is generally referred to as location-based services.

The most challenging aspect of location-based services is the determination of the location of a mobile device. There are generally two competing technologies for location determination (sometimes referred to as positioning) of a mobile device. One includes A-GPS (Assisted Global Positioning System) circuitry within the mobile device such that the mobile device determines its own location relative to a number of satellites and transmits that location to a wireless base station. As a result, the data network which includes the base station has information regarding the location of the mobile device. Another positioning system uses measured signal travel times between the mobile device and a number of wireless base stations to triangulate a position of the mobile device. This system is sometimes generally referred to as U-TDOA (Uplink Time Difference of Arrival).

A-GPS adds significant cost to the mobile device itself and is not universally available. U-TDOA is not widely used and is rather imprecise in the determined mobile device locations produced by that mechanism.

What is needed is a reliable, accurate, inexpensive positioning system that can be adapted to all current mobile devices without modification.

### SUMMARY OF THE INVENTION

In accordance with the present invention, information regarding a site-specific m-commerce transaction is used to determine the general location of a mobile device with which the m-commerce transaction is conducted. For example, if a mobile device is used to pay for parking at a specific location, the mobile device is presumed to be at or near that location at the time the payment is made. All that is required for location determination of the mobile device is a location identifier. In fact, the location identifier can be independent of any m-commerce transaction. For example, signs can be posted at known locations with unique identifiers relative to other locations with invitations to call and enter the identifier of a location to “Learn what's nearby.”

During the transaction, the user specifies the location identifier. To simplify the user interaction, the location identifier can be entirely numeric, avoiding any cumbersome text entry mechanism for data-capable mobile telephones. An m-commerce server retrieves predetermined and previously stored location information associated with the location identifier. The location information can be latitude and longitude coordinates or can be other types of location information such as a street address or survey map coordinates. Locations specified as a street address can be mapped to latitude and longitude coordinates using conventional and available map servers.

Determining a general location of a mobile device, and presumably the location of its user as well, in this manner requires no special equipment or capabilities of the device other than the ability to communicate. In addition, services such as A-GPS and U-TDOA require that the network itself support such positioning services. However, all this is required in the system described herein in accordance with the present invention is that the communications network support ordinary communications. Accordingly, location-based services are available to generally all mobile communications devices, regardless of the availability of special services such as A-GPS and U-TDOA.

### BRIEF DESCRIPTION OF THE DRAWINGS

FIG. 3 is a diagrammatic illustration of a parking administration and positioning system in accordance with the present invention.

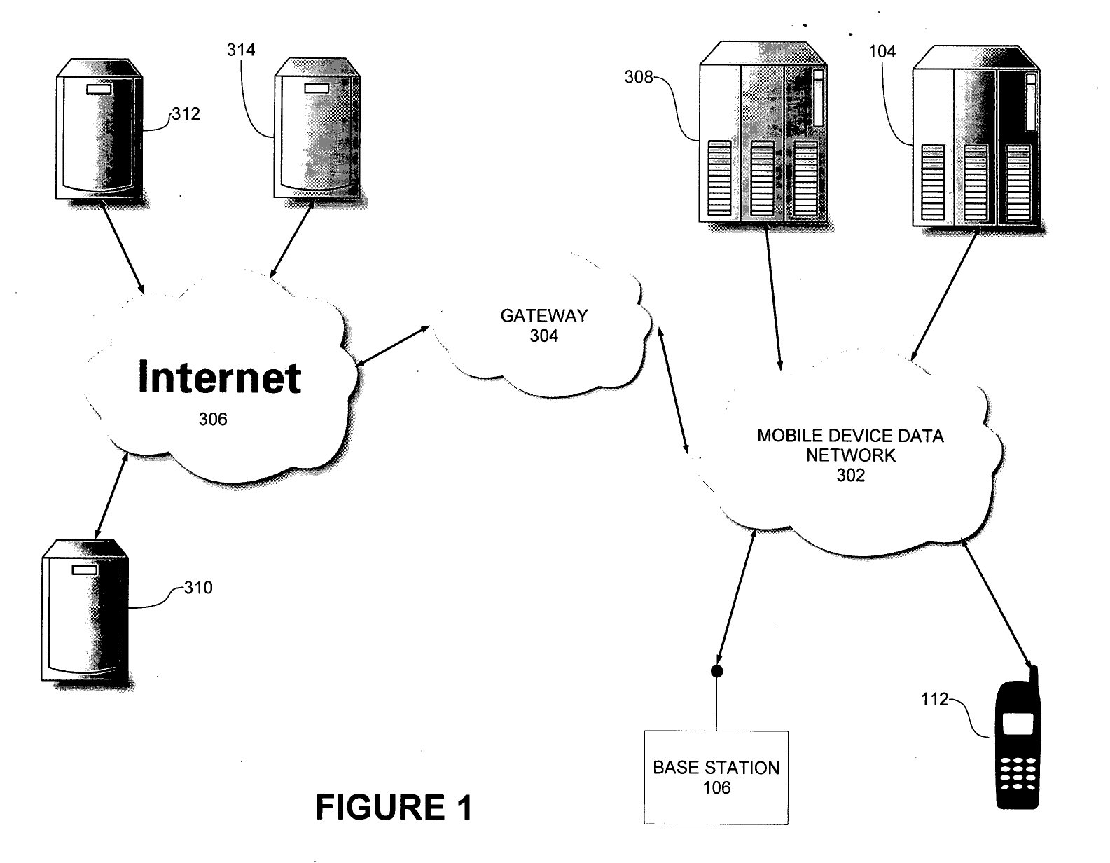

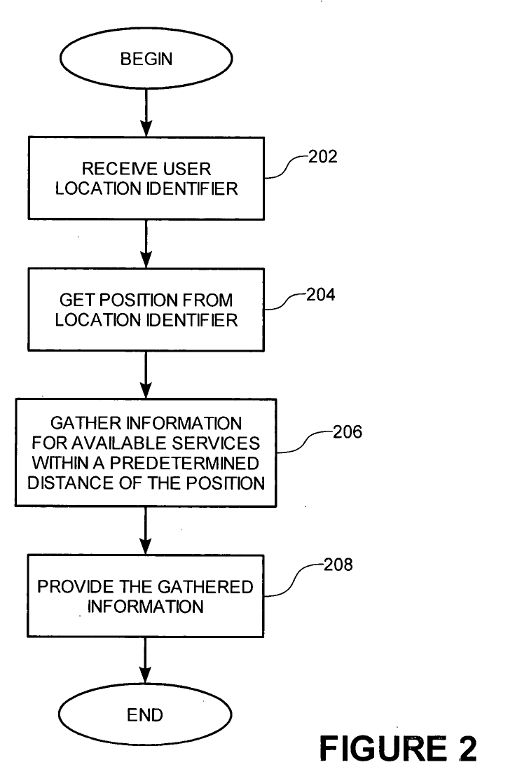

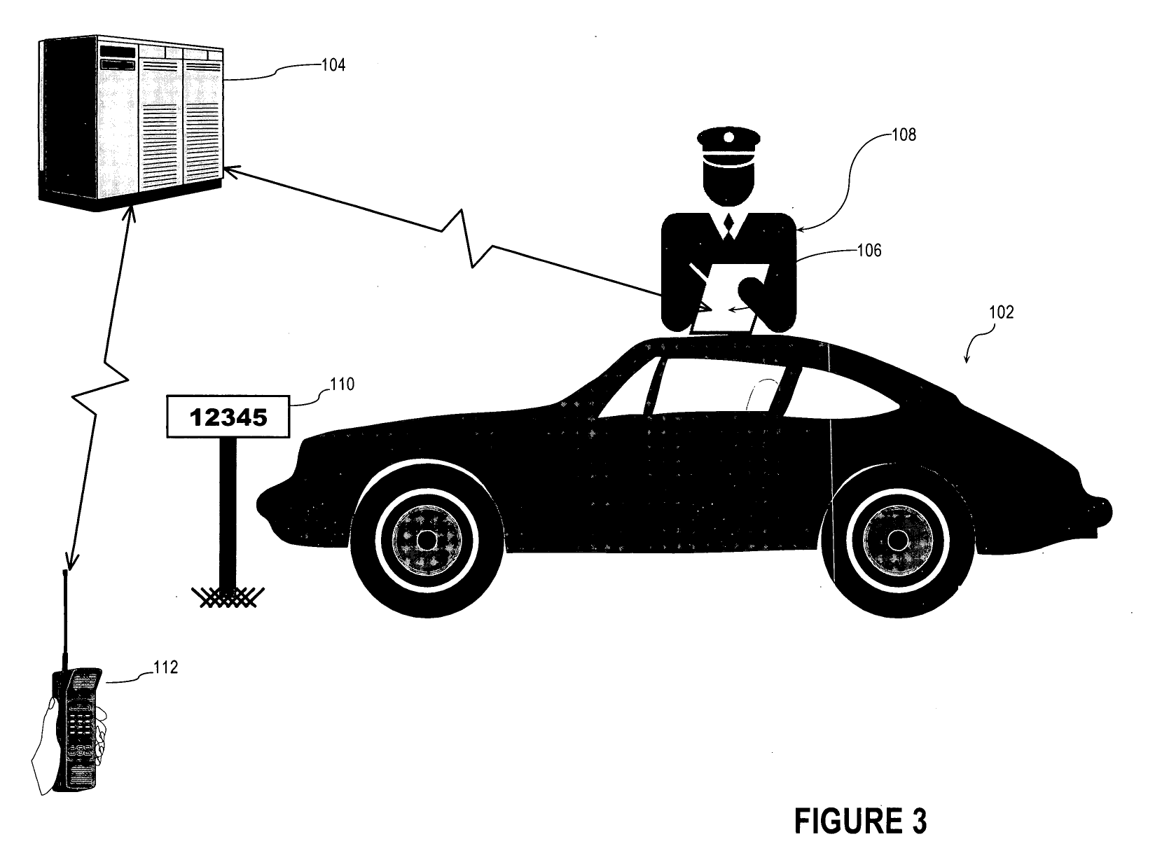

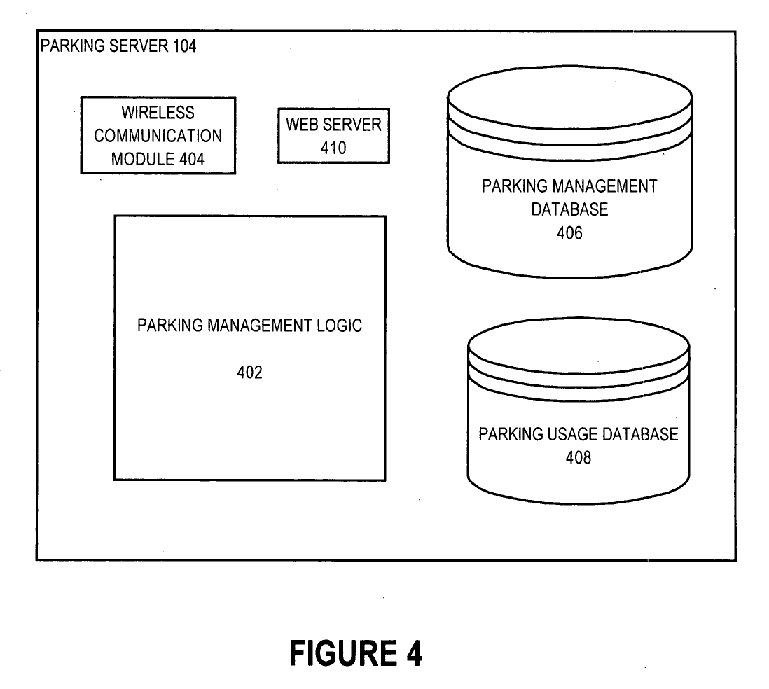

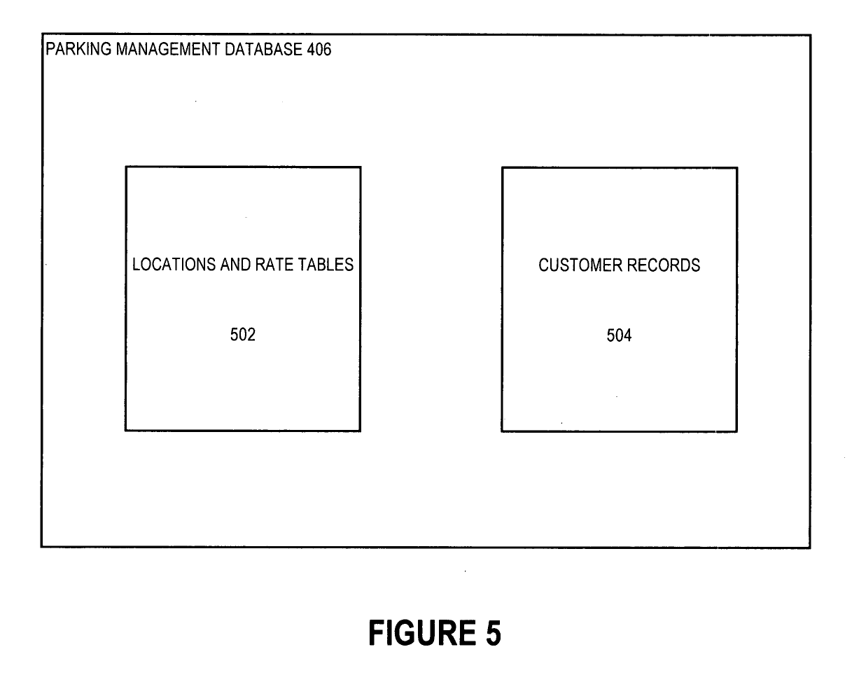

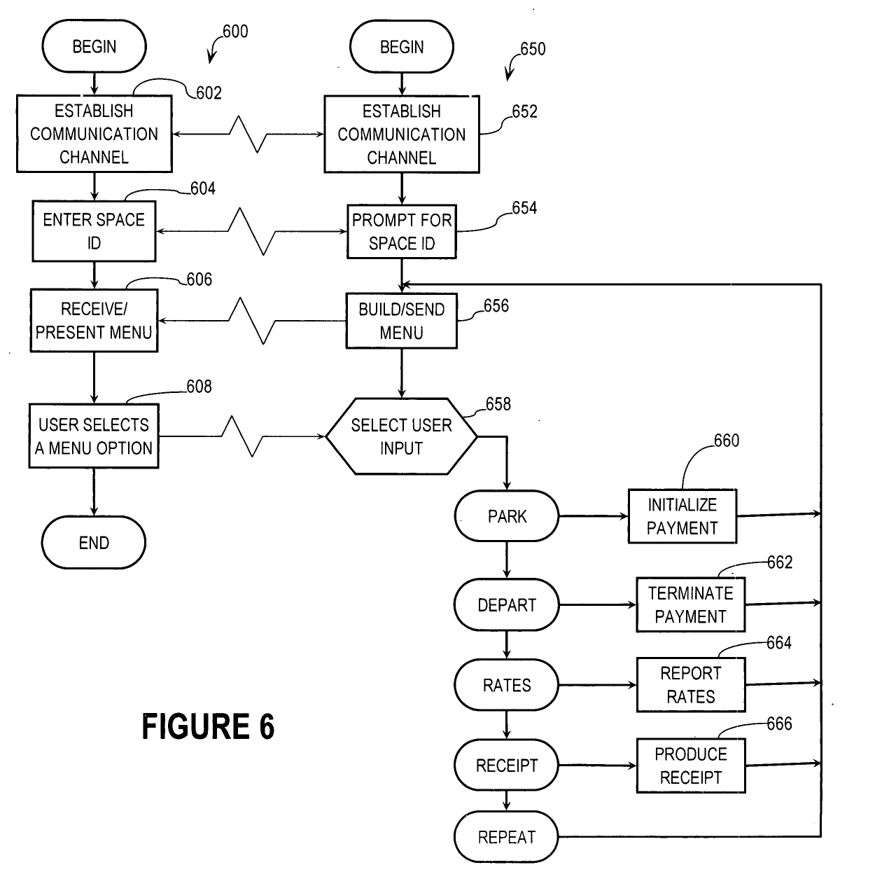

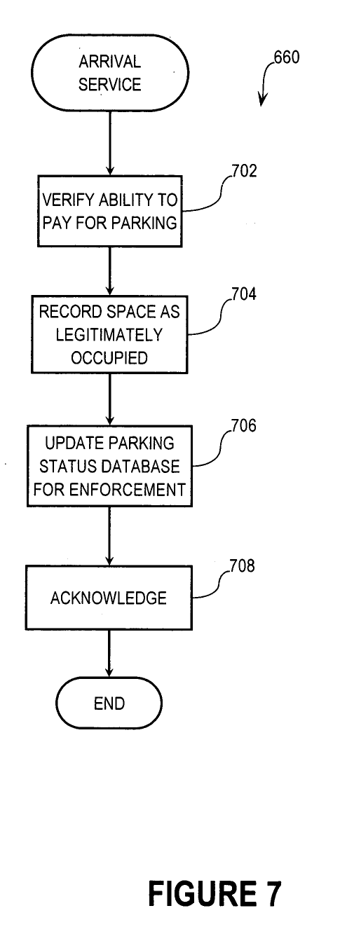

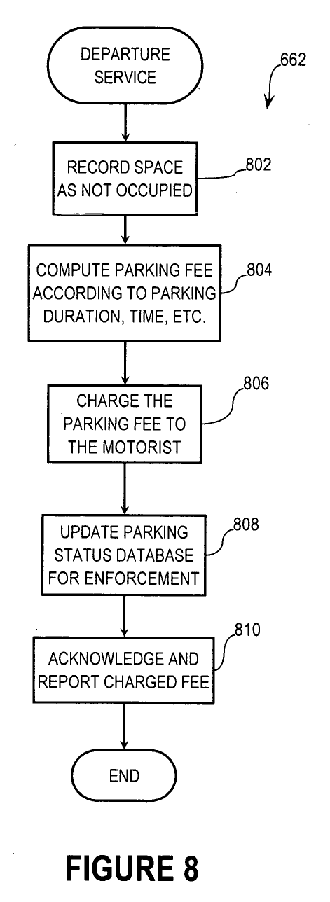

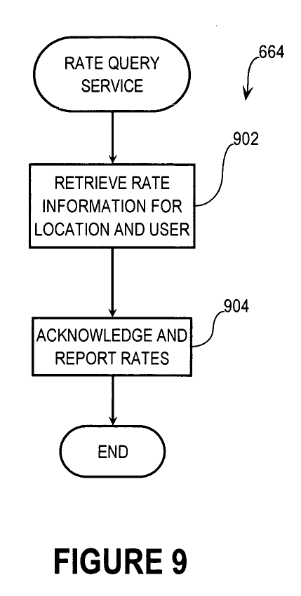

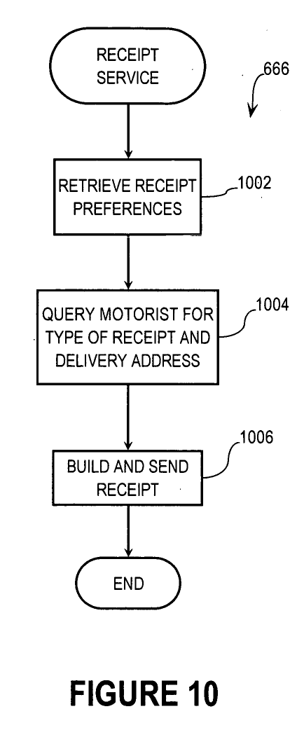

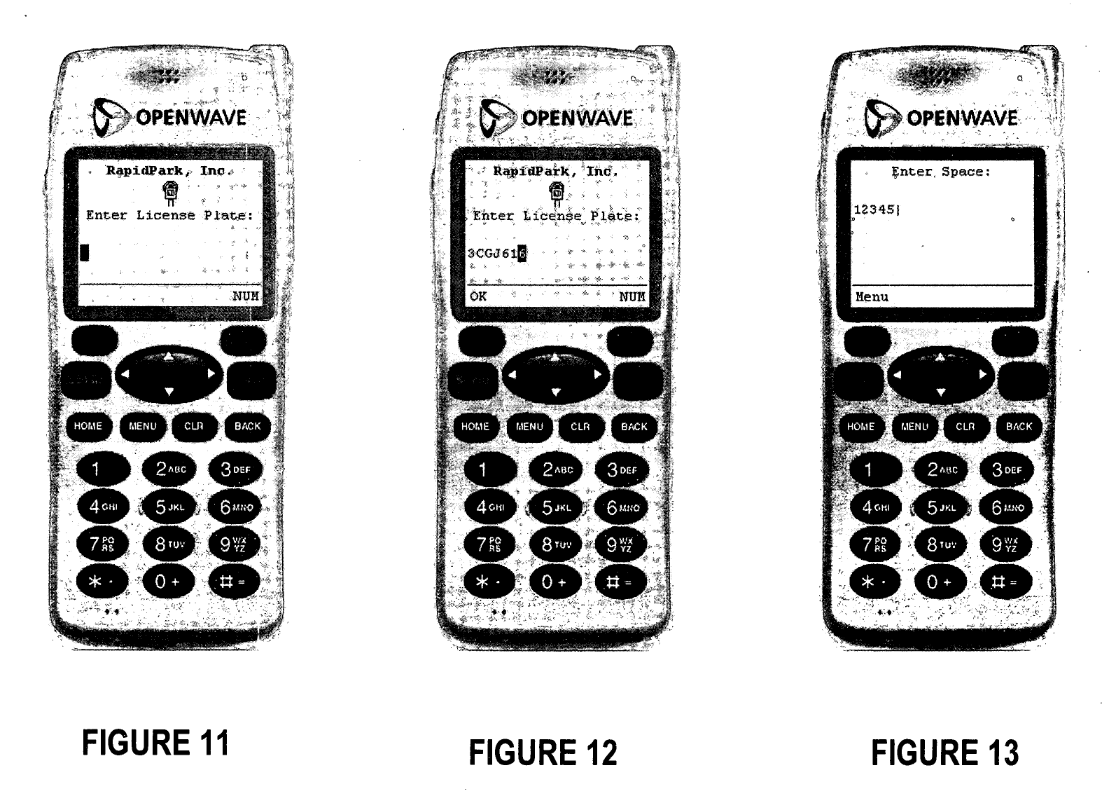

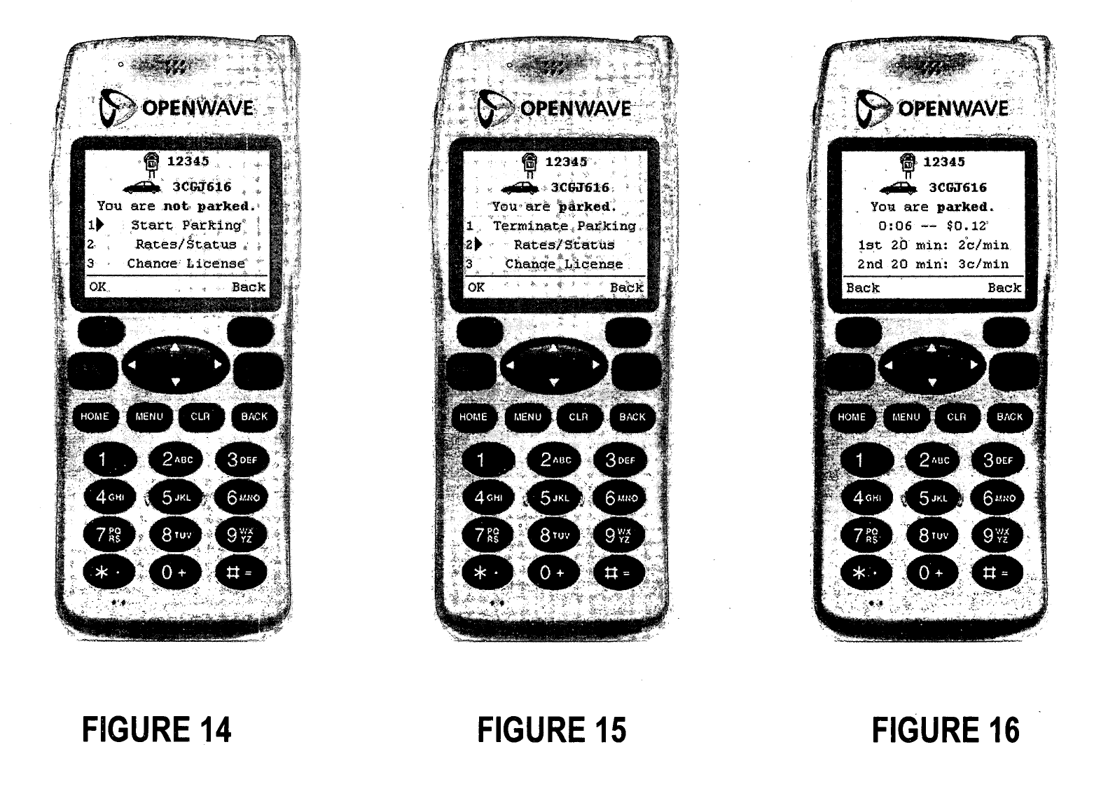

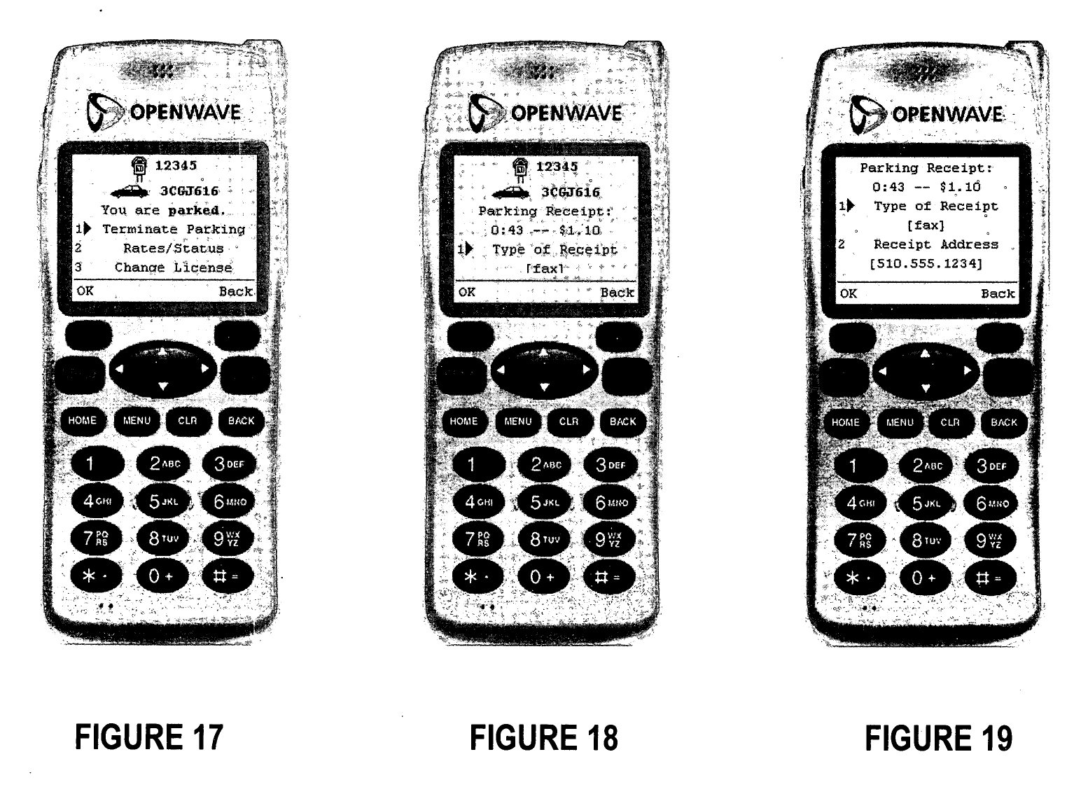

FIG. 2 is a logic flow diagram of the parking administration system of FIG. 3 in providing location-based services.

FIG. 1 is a diagrammatic illustration of the positioning and location-based services system of FIG. 3.

FIG. 4 is a block diagram of the parking server of FIG. 2 in greater detail.

FIG. 5 is a block diagram of the parking management database of FIG. 4 in greater detail.

FIG. 6 is a logic flow diagram of motorist interaction with the parking server of FIG. 4 in accordance with the present invention.

FIG. 7 is a logic flow diagram of the behavior of the parking server in an arrival phase in accordance with the present invention.

FIG. 8 is a logic flow diagram of the behavior of the parking server in a departure phase in accordance with the present invention.

FIG. 9 is a logic flow diagram of the behavior of the parking server in a rate request phase in accordance with the present invention.

FIG. 30 is a logic flow diagram of the behavior of the parking server in a receipt request phase in accordance with the present invention.

FIGS. 11-19 illustrate a WAP (Wireless Application Protocol) based implementation of the user interface by which a motorists controls payment for parking according to the present invention.

### DETAILED DESCRIPTION

In accordance with the present invention, the user of a mobile device 112 (FIG. 1) specifies a location by entering a posted location identifier, such as a parking space location in a electronic parking payment system transaction. The identifier is associated with a specific geographic location within a database within an m-commerce server such as parking server 104.

FIG. 3 illustrates an electronic parking payment system in which the user of a mobile telephone 112 enters a numerical identifier such as that shown on sign 110 to identify a parking space at which the user has parked a car 102. In a transaction described in greater detail below, the user communicates to a parking server 104 that the parking space identified by sign 110 is occupied and paid for with an account associated with mobile telephone 112.

As a result, parking server 104 has information related to the location of mobile telephone 112. Specifically, while the parking space associated with sign 110 continues to be paid for through mobile telephone 112, parking server 104 assumes that mobile telephone 112, and therefore the user of mobile telephone 112, is within walking distance of that parking space.

Electronic parking payment systems generally allow two types of controlling the time during which parking is paid for. In one system, the user calls once to initiate payment for parking and calls again later to terminate payment for parking. In the other system, the user calls once to initiate parking and, during that same telephone call, specifies an amount of time for which parking is to be paid. Other variables affect the time during which parking in a particular location is paid for, such as maximum permissible parking times and allowing the user to call back to extend previously specified parking durations. In any of these systems, parking server 104 has information regarding (i) the establishment of the presence of mobile telephone 112 in proximity to the parking space of sign 110 and (ii) the egress of mobile telephone 112 from the area of that parking space.

For enforcement of parking payment and parking regulations such as maximum parking duration, parking server 104 transmits parking status information to a remote parking control terminal 106 used by parking control officer 108. The parking status information is associated with respective space identifiers to facilitate verification of parking authorization by parking control officer 108. In addition, space identifiers, such as the identifier on sign 110, are associated with a geographic position to facilitate parking enforcement. In one embodiment, the location of the respective parking space of each space identifier is specified in latitude and longitude coordinates which can be initialized once using widely available GPS equipment. In other words, at the time of assignment of the numerical identifier to sign 110 (FIG. 3), a GPS device can be used to determine the latitude and longitude coordinates of sign 110 and/or the specific parking space with which sign 110 is associated and those coordinates can then be stored in a database within parking server 104. In an alternative embodiment, the location of respective parking spaces can be specified as a nearest street address. Other ways of specifying a location can also be used. In any of these embodiments, the information by which the location associated with sign 110 is specified is stored within parking server 104 in such a way that the location information is associated with the identifier of sign 110.

Thus, conducting a transaction in an electronic parking payment system provides an indication that a person is in a general area and the user also provides information regarding how long the user intends to be in that area or, alternatively, subsequently indicates that the user is leaving the area when doing so. The identifier of sign 110 is, in other embodiments, presented in other locations, such as on a parking meter, on the surface of the parking space itself, or on the curb adjacent to the parking space. In addition, identification of a parking lot rather than an individual space also provides information regarding the general location of mobile telephone 112 and, presumably, its user.

It should also be noted that user specification of location information by location identifiers need not necessarily be limited to electronic parking payment systems. Generally any m-commerce transaction which is specific to a particular location at which it is reasonable to assume the mobile device is located can be used as a position indicator of that mobile device. In addition, people can be encouraged to voluntarily identify their positions by posting signs which include a telephone number by which a server such as parking server 104 can be reached and a location identifier—perhaps with an invitation to “Find out what's nearby!” When the number is called and the identifier is received from a mobile communications device such as mobile telephone 112, it can be determined with reasonable certainty that the mobile communications device is within a short walking distance of the location of that sign.

In addition, while the user is entering the location identifier, parking server 104 can ask the user for permission to send advertisements and information regarding services for the location of the user. In cases in which the user calls a telephone number on a sign advertising available information regarding location-based services, such consent can be inferred. However, in cases in which location of the user is inferred from an m-commerce transaction, such a transaction may not be fairly construed as consent to receive advertisements and promotions for location-based services. In such circumstances, it's preferred to get explicit consent from the user to receive such information. During the m-commerce transaction, parking server 104 can interact with the user using IVR techniques and ask permission to send advertisements, promotions, and information regarding location-based services associated with the determined location of the user. In one embodiment, reduce rates are charged for parking for users who agree to receive such information.

A simplified embodiment of the network in which parking server 104 and mobile telephone 112 operate is shown in FIG. 1. Mobile telephone 112 communicates through a mobile device data network 302 which includes a number of wireless base stations to move data and/or voice communications to and from mobile telephone 112 in a conventional and wireless manner. Parking server 104 is reachable by mobile telephone 112 though mobile device data network 302. In this illustrative embodiment, parking server 104 is reachable directly through mobile device data network 302. In an alternative embodiment, parking server 104 is coupled to a wide area network 306 and is reachable through mobile device data network 302 and a gateway 304 which couples mobile device data network 302 to wide area network 306. Wide area network 306 can be the Internet, for example.

A map server 310 is also coupled to Internet 310. Map server 310 is conventional and provides mapping, navigation, and location information. Map servers such as map server 310 are used to provide the well-known mapping and direction services such as MapQuest (<http://www.mapquest.com>) and Yahoo! Maps (<http://maps.yahoo.com>). Such services also provide information related to businesses and services located near a specified geographical location such as a street address. Servers 312 and 314 can also provide information services through Internet 306 in a format which is accessible to mobile devices such as mobile telephone 112. Such services are reachable by mobile telephone 112 through gateway 304 and mobile device data network 302. Similarly, mobile services server 308 can provide information services to mobile telephone 112 through mobile device data network 302. Such information services provided by mobile services server 308 and servers 312 and 314 can include movie times and locations, locations of various types of businesses such as restaurants, hotels, points of interest, reservation interfaces for making reservations for movies, hotel rooms, flights, etc. and information regarding public transportation. One system in which such location-specific information is packaged in a form particularly well-adapted to a mobile device is that provided by PocketThis, Inc. of Oakland, Calif.

Provision of location-based services by parking server 104 is illustrated by logic flow diagram 200 (FIG. 2). In step 202, parking server 104 receives a location identifier entered by the user through mobile telephone 112. In this illustrative embodiment, the identifier is numeric to avoid the inherent difficulties of entering alphanumeric text in the reduced keypad of a mobile telephone. In other embodiments, the identifier can be alphanumeric. The identifier is received in the form of DTMF (dual tone multiple frequency) signals which identify respective keys of mobile telephone 12. In alternative embodiments, the identifier can be received as digital signals such as in the form of an SMS (short message service) or XMS (extensible message service) or MMS (multi-media message service) message or as form data submitted in the context of a WAP (Wireless Access Protocol) document. In yet another embodiment, parking server 104 includes conventional and known speech recognition capabilities and the user of mobile telephone 112 vocally states the identifier through mobile telephone 112.

In step 204, parking server 104 determines the location indicated by the identifier received in step 202. As described briefly above, each identified location is associated with a position specified in some geographical sense. In a preferred embodiment, each identified location is specified with latitude and longitude coordinates. In alternative embodiments, each identified location is specified with some other geographical designation such as a nearby street address, a point of interest such as a well-known landmark, a coordinate system used for property surveying and deed descriptions, or in relation to some other geographical mapping system. Some location specifications such as street addresses can be converted to latitude and longitude coordinates by map server 310.

In step 206, parking server 104 gathers all information within a predetermined distance of the location identified in step 202. In one embodiment, parking server 104 gathers information regarding location-specific services from mobile services server 308, map server 310, and servers 312 and 314 and, in step 206, selects those within the predetermined distance. Any service, e.g., of servers 312 and 314, which is intended to be provided to nearby mobile devices are registered with parking 104. For example, server 312 registers a service with parking server 104 by sending data representing the nature of the service and a manner of invoking the service (such as an address for a link) and a location of the service to parking server 104. Parking server 104 is therefore able to determine whether the service is within the predetermined distance of the identified location of mobile telephone 112 and is also able to send information of the service to mobile telephone 112 when mobile telephone 112 is within the predetermined distance of the service. In an alternative embodiment, parking server 112 broadcasts the location indicated by the identifier received in step 202 to servers 308-314 and awaits responses from servers 308-314 indicating available nearby services.

In addition to gathering information regarding services, parking server 104 also gathers information previously stored with respect to mobile telephone 112, such as user preferences. In particular, the user of mobile telephone 112 may have previously indicated a preference for lower rates in exchange for receiving information regarding location-based services. The user may also have specified the opposite preference, namely, paying slightly higher rates in exchange for not automatically sending such information. Other preferences can include specific types of services the user is willing to accept or specific types of services the user is not interested in as well as a general indication that such location-based service information is welcome. The delivery of such information can depend on such previously entered preferences or on indication of current preferences from the m-commerce transaction itself.

Other criteria can be used to select particular local services about which to inform the user of mobile telephone 112. For example, some services may indicate that they are to be offered only at certain times or certain days of the week or during certain events. A movie theater might specify to parking server 104 that information regarding movies should only be distributed during times at which movies are shown or somewhat before. Browsing history of mobile telephone 112, e.g., particular web sites visited through mobile telephone 112, can be tracked and analyzed for preferences of the user of mobile telephone 112. Those preferences can be used to select information which is particularly likely to be of interest to the user.

In step 208, parking server 104 provides information related to services within the predetermined distance of the identified location. The information can be provided as textual or multimedia messages to mobile telephone 112 of nearby services and special deals. The information can also be sent to mobile telephone 112 in the form of a WAP push. Any such push delivery mechanisms should require consent of the user, either given during the current m-commerce transaction or previously stored as a user preference. Location-based services can also be delivered using a pull mechanism such as WAP-based web browsing in which pages are populated with information regarding services available at locations near mobile telephone 112 and the user thereof. Such pull information delivery mechanism are responsive to requests issued by mobile telephone 112 and therefore can safely infer consent of the user to receive the requested information. In either push or pull delivery mechanisms, the use of the identifier associated with the transaction allows the user to easily and conveniently specify her location to make location-specific information readily available.

In another embodiment, steps 206 and 208 are performed by mobile services server 308. In this embodiment, mobile services server 308 provides services such as those provided by PocketThis, Inc. in that data is collected into objects of various types, including places, which are actionable according to the data type. To leverage from the extensive actions available through such a mobile services server and the ease of use from mobile devices, parking server 104 sends a place object whose location is that of the received identifier to mobile services server 308. Mobile services server 308 puts the received place into a database of data objects associated with mobile telephone 112. Some of the actions associated with a place object in this illustrative embodiment include a “what's nearby?” function and maps and navigation directions relative to the location of the place.

For the sake of completeness, an embodiment of parking server 104 related to electronic parking payment systems relative to individual parking spaces is described in greater detail.

### Parking Server 104

Parking server 104 is shown in greater detail in FIG. 4. Wireless communication module 404 can communicate wirelessly with mobile telephone 112. Parking server 104 also includes a web server 410 which provides traffic status information through the Internet to wireless communication module 304 (FIG. 1) of remote parking control terminal 106.

Parking management logic 402 controls the behavior of parking server 104. Parking management logic 402 can include circuitry logic and/or a general purpose computer processor and associated computer instructions and data stored in memory to cause the behavior described herein.

Parking management database 406 stores data specifying information pertaining to all parking resources managed by parking server 104 and is shown in greater detail in FIG. 5. Locations and rates tables 502 specifies parking rates at various parking locations under management by parking server 104. Customer records 504 includes data describing various customers who can manage parking through use of parking server 104. In this illustrative embodiment, no previous contact between the motorist and parking server 104 is required. Thus, it is not a prerequisite that a user record corresponding to the motorist exists within customer records 504 to pay for parking through parking server 104. However, even so, parking server 104 stores customer records 504 in this illustrative embodiment such that returning customers are not required to specify vehicle identification each time parking is to be paid for.

Logic flow diagram 600 (FIG. 6) illustrates operation of mobile telephone 112 and logic flow diagram 650 illustrates co-operation of parking server 104. In step 602, the motorist causes mobile telephone 112 to establish a wireless communications link with parking server 104. In one embodiment, mobile telephone 112 is a mobile telephone and the motorist establishes the communications link by dialing a telephone number by which parking server 104 is reached. The telephone number can be widely advertised and/or posted on signs in parking areas such that motorists in general have access to the telephone number by which parking server 104 is reached. In this illustrative embodiment, the parking spaces associated with a particular telephone number are in the form of a parking lot and the telephone number is printed on one or more signs which are clearly visible throughout the parking lot. Many currently available mobile telephones allow the motorist to program the telephone number such that the motorist can initiate communication with parking server 104 using a single button press. Thus, motorists who frequently park in the same parking lot or region which shares a common telephone number can initiate parking payment with a single button press on mobile telephone 112.

In step 652, parking server 104 cooperates with mobile telephone 112 to establish the communications link. In establishing the communications link, several pieces of information are communicated to parking server 104. The identity of the motorist is communicated to parking server 104 by identification of mobile telephone 112. Mobile telephones identify themselves to base stations according to currently used wireless communications protocols. Regardless of whether such identification information is available to the recipient of the telephone call, the calling mobile telephone communicates such information, and such information is made available to parking server 104. Parking server 104 also notes the time at which the wireless communications link is established. As described more completely below, the noted time can be the time at which parking is either started or terminated.

In step 654, parking server 104 prompts the motorist to specify vehicle identification data and parking space identification data. While it is appreciated that prompts and supplied data described herein can include pre-recorded and/or synthesized voice signal played to the motorist through mobile telephone 112 and DTMF signals generated by the motorist pressing one or more buttons on mobile telephone 112, an alternative embodiment employing a WAP interface is shown in FIGS. 11-19. As shown in FIG. 31, parking server 104 sends data causing mobile telephone 112 to prompt the motorist to enter the characters of the license plate of vehicle 102. In yet another embodiment, wireless communication module 404 includes conventional and known speech recognition capability and the user enters information by simply vocally stating the information into mobile telephone 112. In step 604, the motorist enters the license plate of vehicle 102 as shown in FIG. 32. Also in steps 654 and 604, parking server 104 prompts the motorist to specific data identifying the parking space in which the motorist intends to park as shown in FIG. 33.

In this illustrative embodiment, sign 110 has a space identification number printed on its face. In general, parking spaces in parking lots are marked and association of sign 110 with a marked parking space is sufficient to associate the parking space identifier printed on sign 110 with vehicle 102. However, vehicle identification serves as a back-up for the motorist. For example, if the motorist inadvertently entered an erroneous space identification, records in parking usage database 408 indicating that vehicle 102 was authorized to park, albeit at a different location, any citation received by the motorist as a result of the erroneous space identification can be waived.

In step 656, parking server 104 prepares and sends a menu to mobile telephone 112. In this illustrative embodiment, the menu includes synthesized or prerecorded voice prompts to which the motorist responds by pressing keys on mobile telephone 112 or by speaking verbal responses into mobile telephone 112. Parking server 104 interprets the responses of the motorist by recognizing DTMF tones and/or recognizing spoking words of the motorist using conventional techniques. In this illustrative embodiment, the menu includes the following options: (1) park (if the motorist is not currently parked), (2) depart (if the motorist is currently parked), (3) list rates for parking, and (4) produce a receipt for the current or most recent parking.

In step 604, mobile telephone 112 receives the menu from parking server 104 and presents the menu to the motorist. FIG. 34 shows as illustrative example of such a menu according to the WAP interface. The space identifier of sign 110 as entered by the motorist is indicated for confirmation of proper space identification. Vehicle 102 is identified to the motorist for confirmation of proper vehicle identification. The current parking status is indicated as “not parked” to indicate that parking is not currently paid for and therefore not currently authorized.

In step 608, the motorist uses mobile telephone 112 to select from the received and presented menu. For example, in response to the voice prompt “Press One to Pay for Parking,” the motorist presses a “1” key on mobile telephone 112. Similarly, as shown in FIG. 34, the “1” key is associated with a command by which the motorist can “Start Parking.”

In step 658, parking server 104 receives and interprets the motorist's response to the menu. If the motorist's response indicates parking is to be initiated, parking server 104 performs step 660. If the motorist's response indicates parking is to be terminated, parking server 104 performs step 662. If the motorist's response indicates a request for rate information, parking server 104 performs step 664. If the motorist's response indicates a request for a receipt, parking server 104 performs step 666. After any of steps 660-666, parking server 104 repeats steps 654-658 until the motorist terminates the wireless communications link with parking server 104.

Step 660 in which parking management logic 402 (FIG. 4) of parking server 104 initiates payment for parking is shown in greater detail as logic flow diagram 660 (FIG. 7). In step 702, parking management logic 402 verifies that the motorist is able to pay for parking through mobile telephone 112. Parking management logic 402 identifies the motorist through mobile telephone 112. As described above, mobile telephone 112 (FIG. 3) identifies itself when establishing a communications link with parking server 104. Within parking management database 406, mobile telephone 112 is associated with the motorist owner of mobile telephone 112, with vehicle 102, and with the parking space identified by sign 110. Parking management database 406 also associates payment method data with the motorist user of mobile telephone 112. Such payment method data can include, for example, (i) a credit and/or debit card account number and associated billing data previously specified by the motorist using conventional user interface techniques (e.g., during account set-up through the world wide web), (ii) a pre-paid account number and balance, and (iii) data indicating that a wireless telephone service company will vouch for payment by the motorist and will assume responsibility for collecting funds from the motorists.

If a wireless telephone service company will vouch for payment by the motorist, no registration is required by the motorist prior to paying for parking in the manner described herein. Instead, the wireless telephone service company merely adds any parking charges incurred by use of mobile telephone 112 to any bill sent to the owner of mobile telephone 112.

Other payment methods generally require registration of the motorist prior to paying for parking. It is generally easier for the motorist to register parking payment methods using a standard, full-size computer in communication with parking server 104 through the Internet. However, it is preferred that registration is made available to the motorist through mobile telephone 112 such that the motorist can specify one or more payment methods using mobile telephone 112 and conventional user interface techniques.

In this illustrative embodiment, parking management logic 402 merely verifies that the motorist's account has sufficient funds to cover a maximum parking fee and postpones retrieving funds from the motorist's account until parking is terminated as described below. In an alternative embodiment, parking management logic 402 immediately retrieves funds from the motorist's account for a maximum parking fee and subsequently returns excess funds, if any, to the motorists account upon termination of parking by the motorist.

In step 704 (FIG. 7), parking management logic 402 (FIG. 4) records the parking space associated with sign 110—identified by the motorist in step 604 (FIG. 6)—as legitimately occupied in parking usage database 408. Parking management logic 402 also records vehicle 102—as identified in step 604—as authorized to park at the current time within parking usage database 408. In one embodiment, parking management logic 402 presents the motorist with an opportunity to specify a different vehicle and/or a different parking space using conventional user interface techniques. For example, menu option “3” shown in FIG. 34 allows the motorist to specify a different vehicle license plate.

Parking management logic 402 records the parking space associated with sign 110 as legitimately occupied by storing a record in parking usage database 408 which identifies the parking space, vehicle 102, and a parking beginning time and no parking end time. The authorization for parking of vehicle 102 is implicit in the omitted parking end time in an alternative embodiment, the authorization for parking of vehicle 102 is explicitly represented in parking management database 408.

In step 706 (FIG. 7), parking management logic 402 (FIG. 4) updates parking status as reported to parking control personnel to indicate that the parking space associated with sign 110 is legitimately occupied. In an alternative embodiment, such status is generated from parking usage database 408 upon request by remote parking control terminal 106 in a manner described more completely below. This alternative embodiment therefore skips step 706.

In step 708, parking management logic 402 acknowledges successful receipt and acceptance of the parking initialization data recorded in step 704. Specifically, parking management logic 402 provides confirmation through wireless communication module 404 to mobile telephone 112 to the motorist.

After step 708, processing according to logic flow diagram 660, and therefore step 660 (FIG. 6), completes. Thus, the motorist indicates through wireless communication device 112 that the motorist intends to pay for parking and the payment is acknowledged through mobile telephone 112. For example, in the embodiment illustrated in FIGS. 11-19, the menu built and sent in the subsequent performance of step 656 indicates that vehicle 102 is authorized to park at parking meter 110 as shown in FIG. 35 (“You are parked.”).

Continuing in the activity flow illustrated in FIGS. 11-19, the motorist next requests rate information as described below in the context of step 664 (FIG. 6) and FIG. 36. Later, after termination of communications between mobile telephone 112 and parking server 104, the motorist uses mobile telephone 112 to again contact parking server 104 to terminate payment for parking by selecting the appropriate menu option as shown in FIG. 37. In response, parking server 104 performs step 662 (FIG. 6).

Step 662 in which payment for parking is terminated is shown in greater detail as logic flow diagram 662 (FIG. 8). In step 802, parking management logic 402 of parking server 104 records the parking space associated with sign 110 as no longer legitimately occupied by storing data so indicating within parking usage database 408. Parking management logic 402 identifies vehicle 102 and the space identifier of sign 110 as pertaining to the current transaction in the manner described above with respect to logic flow diagram 660 (FIG. 7). Briefly, such information is entered by the motorist upon initial contact with parking server 104 as described above with respect to steps 654 and 604. Since mobile telephone 112 was recently used to initiate payment for parking in a transaction involving vehicle 102 and the space identifier of sign 110, parking server 104 can use that information to simplify the transaction with the motorist. In particular, if mobile telephone 112 has been previously used to identify vehicle 102 and parking meter 110, such identification is retrieved and offered to the motorist as default values which can be quickly confirmed, preferably using a single user interface gesture.

In this illustrative embodiment, the menu sent to mobile telephone 112 in step 656 is configured by parking management logic 406 to omit a menu option to start payment for parking if vehicle 102 is recorded as parked or to omit a menu option to terminate payment for parking if vehicle 102 is not recorded as parked. Such is shown in FIGS. 11-19. Parking management logic 406 can record vehicle 102 as no longer parked at the space identified by sign 110 in step 802 (i) implicitly by recording a parking end time in parking usage database 408 and/or (ii) explicitly within parking usage database 408.

In step 804 (FIG. 8), parking management logic 402 (FIG. 4) determines the fee for parking. The fee can be generally based on any formula from one as simple as a flat rate to one based on a complex formula involving—among other factors—the duration for which vehicle 102 was parked, the particular space or area in which vehicle 102 was parked, the time of day, the day of the week, holiday status, a particular rate plan associated with the user, and current parking usage for a particular region. To determine the fee, parking management logic 402 (FIG. 4) can use locations and rate tables 502 (FIG. 5) and/or customer records 504.

In step 806 (FIG. 8), parking management logic 402 (FIG. 4) charges the user the fee determined in step 804. The fee can be charged in a number of ways. For example, a debit account can be associated with the user and represented in customer records 504. The fee can be charged by deducting the fee from the debit account. To preserve coinless parking privileges, the user would periodically replenish the debit account. Parking server 104 can report the debit account balance to the user in a periodic statement mailed to the user and/or in acknowledgments sent in steps 708, 810, and 904. Any balance information in such acknowledgments can be presented to the user as voice played through, or textually and/or graphically within a display of, mobile telephone 112.

The fee can also be charged by accumulating accrued charges and sending a periodic bill for subsequent payment. Alternatively, the fee can be charged by applying the fee to a credit account or a wireless communications service account associated with the user within customer records 504.

In step 808 (FIG. 8), parking management logic 402 updates parking status as reported to parking control officer 108 to remove any indication that the parking space identified by sign 110 is legitimately occupied. In an alternative embodiment, such status is generated from parking usage database 408 upon request by remote parking control terminal 106 in a manner described above with respect to step 706 and more completely below. This alternative embodiment therefore skips step 808 (FIG. 8).

In step 810, parking management logic 402 acknowledges successful receipt and acceptance of request to terminate payment for parking. In this illustrative embodiment, parking management logic 402 sends an acknowledgment in the form of a voice message played to the motorist through mobile telephone 112 in response to the menu selection initiating step 662 and can further include SMS messages to the parking control officer and any owner or operator of the area in which vehicle 102 has been parked. In the embodiment illustrated in FIGS. 11-19, terminating parking payment by the motorist automatically transfers to step 666 (FIG. 6) to produce a receipt as shown in FIGS. 17-19 as described more completely below. The automatic transfer to step 666 confirms to the motorist acceptance of termination of payment for parking by parking server 104.

Step 664 (FIG. 6), in which parking rates are reported, is shown in greater detail as logic flow diagram 664 (FIG. 9). In step 902, parking management logic 402 (FIG. 4) determines a schedule of rates for the motorist, region, and time inferred from identification of mobile telephone 112 in the manner described above. To the extent other factors are used in calculating fees, those factors are taken into consideration in determining the fee schedule such that the fee schedule accurately represents relevant information to the motorist. The schedule includes sufficient information that the motorist is fully apprised of the rate to be paid. For example, if the parking rate is a flat rate regardless of time or flat rate with a maximum duration, the fee schedule so indicates. Similarly, if the parking rate is a fixed fee for a first duration, changes to a per 15-minute period charge for a second duration, and increases to a per minute charge for a third duration; such information is completely and accurately represented in the fee schedule.

In step 904 (FIG. 9), parking management logic 402 acknowledges receipt of the rate request and reports the fee schedule to the motorist. For example, the fee schedule can be presented to the motorist as a voice signal through mobile telephone 112. In the embodiment illustrated in FIGS. 11-19, the motorist requests rate information as shown in FIG. 35 and the rates are reported to the motorist as shown in FIG. 36. The rate report in this illustrative embodiment reports parking status as “parked,” identifies vehicle 102 and parking meter 110, and indicates that vehicle 102 has been parked for six (6) minutes for an accrued fee of $0.12. Furthermore, the rate report indicates that the rates for parking at parking meter 110 are (i) 2¢ per minute for the first 20 minutes, (ii) 3¢ per minute for the next 20 minutes, and (iii) 10¢ per minute beyond 40 minutes.

After step 904 (FIG. 9), logic flow diagram 664, and therefore step 664 (FIG. 6), completes. Since the rates are reported to the motorist through mobile telephone 112, the motorist can immediately proceed to pay for parking by selecting the appropriate menu option in the subsequent iteration of steps 604-606 and 654-666 if the reported rates are acceptable to the motorist.

Step 666 in which parking server 104 provides a receipt for parking is shown in greater detail as logic flow diagram 666 (FIG. 30). In step 1002, parking management logic 402 retrieves receipt preferences of the motorist from parking management database 406. Such preferences include data specifying one or more types of receipts and delivery addresses for each type. Types of receipts include fax, e-mail, and paper, for example.

In step 1004, parking management logic 402 prompts the motorist to specify a type and address of receipt. In preparing the prompt, parking management logic 402 determines whether the motorist has previously specified a preferred type of receipt and an associated preferred address and presents the preferred type and address to the motorist as a default response. For example, if the motorist has previously specified that fax receipts are preferred and has specified a corresponding fax telephone number to which receipts should be sent, the prompt can be a voice signal saying, for example, “To send the receipt by fax to your default location, press ‘1.’ To specify a different fax telephone number, press ‘2.’ To send the receipt by a method other than fax, press ‘3.’” Parking management logic 402 interacts with the motorist through mobile telephone 112 in step 1004 to allow the motorist to specify both the type of delivery and delivery address of the receipt. In the embodiment shown in FIGS. 11-19, any default values are included in the receipt dialog as shown in FIGS. 18-19. In particular, the motorist presses the “1” key to change the type of receipt to some type other than “fax” and presses the “2” key to change the receipt address to an address other than the telephone number, (510) 555-1234. To send the receipt, the motorist presses the “ACCEPT” soft-key which is labeled “OK.”

In step 1006, parking management logic 1006 builds and sends the receipt by the specified method and to the specified address. In this illustrative embodiment, parking management logic 402 includes the following information in the receipt: (i) identity of the motorist, (ii) identity of vehicle 102, (iii) a relatively unique transaction identifier, (iv) beginning and end times and dates for the period during which vehicle 102 was parked, (v) the amount charged to the motorist, and (vi) the source of payment (e.g., debit account, wireless communications provider, credit card account, etc.). The receipt can also identify a region in which vehicle 102 was parked and the authority managing parking within that region as well as contact information of the parking authority for questions regarding the parking transaction. Parking management logic 402 causes the receipt to be sent to the specified delivery address using conventional techniques.

### Parking Control

Current and accurate parking information is made available to parking control officer 108 through remote parking control terminal 106. In this illustrative embodiment, remote parking control terminal 106 is a portable computer with the capability of accessing the World Wide Web through a wireless Internet connection. Examples include notebook computers, pen-based palmtop computers, and personal digital assistants (PDAs). In this illustrative embodiment, parking management logic 402 (FIG. 4) includes web server 410 which is described above and which sends current and accurate parking information to requesting personnel. In particular, remote parking control terminal 106 sends a request for parking information in the form of a URL (universal resource locator) which includes data specifying a location of remote parking control terminal 106.

The location can be determined using conventional GPS (global positioning satellite) technology or can be simply fixed, predetermined data specifying a zone of responsibility for parking control personnel 108. Alternatively, parking control officer 108 can enter an identifier of a nearby parking space to thereby use the location of the parking meter as an approximate location of parking control officer 108. In embodiments in which parking control officer 108 patrols a relatively small parking area such as a single parking lot, location of remote parking control terminal 106 is not needed since parking control officer 108 would not require navigational assistance to a particular parking space. In particular, parking control officer 108 can be familiar with the general location of each parking space within a parking lot of relatively moderate size. Thus, in such an embodiment, location information pertaining to remote parking control terminal 106 can be omitted.

The web server of parking management logic 402 responds to the request by retrieving data from parking usage database 408 pertaining to parking regions in the general area of the location of remote parking control terminal 106. The resulting list of vehicles which are authorized to park and parking spaces in which vehicles are authorized to park can be viewed and rearranged by parking control officer 108 using conventional user interface techniques. Such techniques can include, for example, clicking on a column of parking space identifiers to sort the parking information by parking space identifiers, clicking on a column of vehicle license plate numbers to sort the parking information by vehicle license plate numbers, and/or clicking on a column of expiration times or parking times to sort by either respective parameter. Similarly, if geographical location data is associated with each identified space, the parking status data can be sorted according to such geographical locations. In a particularly advanced user interface for parking control officer 108, remote parking terminal 106 can display a moving map corresponding to movement of parking control officer 108 as determined by GPS technology, for example. The moving map shows individual parking spaces, for each parking space, indicates whether parking is authorized and, if so, any associated expiration time.

Sorting by various fields provides a very useful interface for parking control officer 108. As parking control officer 108 patrols parking space, sorting by space identifier enables parking control officer 108 to quickly determine if a particular parking space is occupied but not paid for. By sorting according to vehicle identifier, parking control officer 108 can quickly determine if a particular vehicle is authorized to park—and, in particular, to determine if a vehicle occupying an unpaid-for space is authorized to park. Such can be the case if the motorist inadvertently entered an erroneous space identifier but accurately identified her vehicle.

### Fixed Parking Term Embodiment

In an alternative embodiment, parking is reserved for a user-specified amount of time after which parking is no longer authorized and a citation can be issued by parking control officer 108. Thus, the parking fee model in this embodiment is more analogous to the manner in which currently used parking meters work. In this alternative embodiment, parking management logic 402 prompts the motorist to enter a requested amount of time using, for example, DTMF signals from mobile telephone 112 prior to step 702 (FIG. 7). The fee for parking the requested amount of time is charged to the motorist immediately in step 702 in the manner described above with respect to steps 804-806 rather than upon departure from the parking location. Accordingly, steps 804-806 are skipped upon departure by the motorist. In addition, since expiration time is known by parking management logic 402 (FIG. 4), expiration time of parking payment can be represented to the motorist through mobile telephone 112 and can be included in display 310 of remote parking control terminal 106. Accordingly, parking control personnel 108 can request that local parking information is sorted by expiration time to therefore efficiently police parking by looking specifically for vehicles whose parking authorization is about to expire.

Parking server 104 can be configured to warn users as parking authorization is about to expire. In particular, customer records 504 can include contact information such as a delivery address for SMS or other text messages, e.g., to mobile telephone 112 or an alphanumeric pager, and warning preferences of the user. Parking management logic 402 can send timely warning of imminent parking expiration to the specified delivery address to thereby warn the motorist. Upon warning of imminent parking expiration, the motorist can be presented with an opportunity to respond to the warning with a request to extent parking authorization.

Of course, the motorist can be notified of events other than termination of a fixed parking term. For example, if the applicable parking rate is graduated and is about to increase, the imminence of the increase in parking rate can be sent to the motorist, providing the motorist with the opportunity to vacate the parking space before the rate increases.

The above description is illustrative only and is not limiting. Instead, this description is merely illustrative, and the present invention is defined solely by the claims which follow and their full range of equivalents.

1. A method for providing location-based services to a mobile communications device, the method comprising:
receiving signals from the mobile communications device which indicate an identifier of a location;
determining a position of the location;
determining that one or more services available to the mobile communications devices are associated with respective positions within a predetermined distance of the position of the location; and
sending information regarding the one or more services to the mobile communications device.
